(19) United States
(12) Patent Application Publication
(10) Pub. No.: US 2019/0277227 A1
(43) Pub. Date: Sep. 12, 2019

(54) AIR FILTRATION DEVICE

(71) Applicant: Kros-Wise, Inc., San Diego, CA (US)

(72) Inventor: Kenneth James Larson, Escondido, CA (US)

(21) Appl. No.: 15/915,005

(22) Filed: Mar. 7, 2018

(51) Int. Cl. F02M 35/022; B01D 45/12; B01D 46/48

(52) U.S. Cl. CPC F02M 35/0223; B01D 46/0005; B01D 46/48; B01D 45/12

(57) ABSTRACT

The Air Filtration Device of this invention is a highly efficient air cleaner that utilizes spinning air at high speed to separate out and remove dirt particles from an air flow such as intake air taken ingested by internal combustion engines. This Device it is well-suited for use with both normally-aspirated engines and turbocharged engines. This Device is superior to current automotive air cleaners that filter out dirt by use of a screen or porous media since it never becomes clogged as dirt is filtered from raw intake air. Additionally, the dirt separation tube of this invention allows proper engine intake flow and, among other applications, efficiently removes the specific sizes of dirt particles that can be ingested in off-road and highway vehicle operations.

### BACKGROUND OF THE INVENTION

The present invention relates to the efficient removal of dirt particles and similarly-sized foreign matter from intake air that is ingested by internal combustion engines, including both normally-aspirated and turbocharged engines and engines of either type that may be used in both off-road and on-road vehicles.

Many currently-used automotive air cleaners filter out dirt by use of a screen or porous media. This is less efficient for removing many types of dirt particles since the filter media becomes clogged over time and needs to be replaced, including those commonly ingested by vehicles off-road or on highways. An alternative air cleaner, which employs technology used with helicopter engines, utilizes particle separation but requires the use of an external fan to separate out the dirt, and also is less efficient at the relatively low flow rates produced by the engines of automotive or off-road vehicles. The present invention is an improvement over both of these other types of air cleaners, in that it never becomes clogged which would degrade performance nor requires expensive replacement of the filter at relatively low intervals while also effectively removing dirt particles at typical automotive/off-road engine air flow rates and having the further advantage of being capable of operating without an expensive noisy external electric fan which requires power to be supplied by the automotive electric system.

### SUMMARY OF THE INVENTION

The air filtration device of this invention separates out dirt, sand, and other foreign particles to allow clean intake air to flow into an engine.

In a preferred embodiment of this invention, the air filtration assembly is a replacement of the OEM filter and attaches directly to an engine's air intake port, outside air flows into the assembly and is filtered through multiple cyclonic tubes that spin the intake air at high velocity. The filtered-out particles are collected in a chamber of the device and cleaner, filtered air is sent through into the engine.

In another preferred embodiment, the air filtration assembly can be utilized as a “pre-filter” to take in air, filter out dirt and other foreign particles, and send the air into the vehicle's existing filter system, through which the air eventually passes into the vehicle's engine.

### BRIEF DESCRIPTION OF THE DRAWINGS

FIG. 1 shows the entire air filtration device in the preferred embodiment in which the device attaches directly to an engine's air intake port and serves as the primary air filtration system for the engine.

FIG. 2 shows the air filtration device in another preferred embodiment, in which the device serves as a pre-filter and is attached to the vehicle's existing filter system.

FIG. 3 is a diagram illustrating one of the cyclonic dirt separation tube assemblies comprised of an outer tube (3) and an inner tube (4).

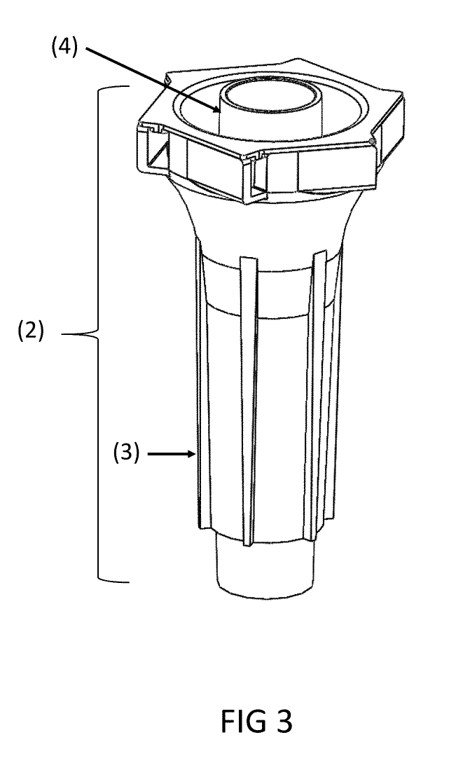

FIG. 4 is a diagram illustrating an exploded view of one of the device's cyclonic dirt separation tubes, composed of an inner tube (4) housed inside an outer tube (3).

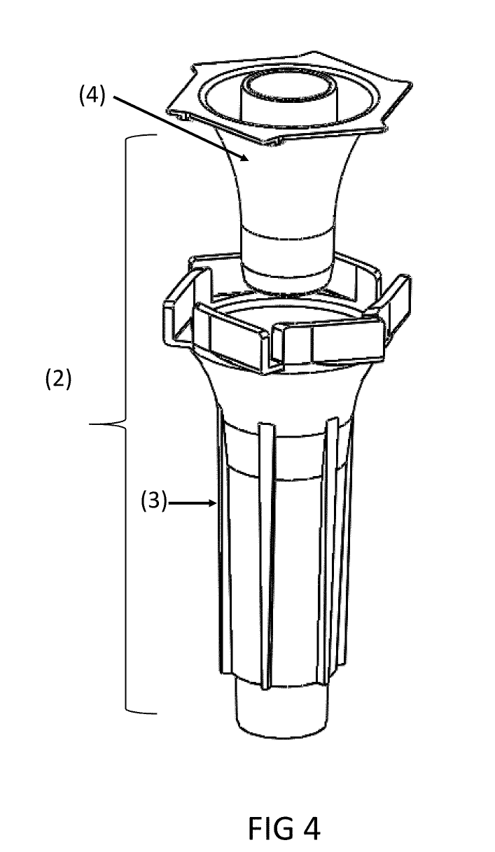

FIG. 5 is a diagram illustrating the operation of a cyclonic dirt separation tube, showing how the dirt particles and other foreign particles are separated from the intake air, while clean air exits from the top of the tube and then toward the engine.

FIG. 6 is a diagram of a view of the entire air filtration device showing each of its component parts.

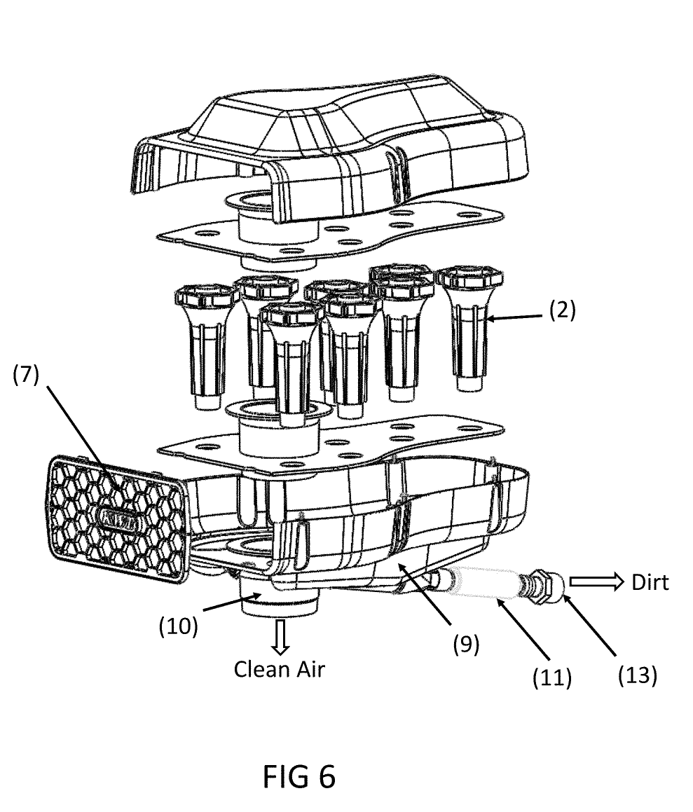

### DESCRIPTION OF THE PREFERRED EMBODIMENTS

As used herein, the following terms include, but are not limited to, the following meanings.

The term “clean air plenum” means the chamber of the air cleaner where clean air flows to the engine.

The term “dirt collection chamber” means the chamber of the air cleaner where dirt after separation from air is deposited.

The term “dirt clean-out tube” means the lowest point in the assembly below the dirt collection chamber used to facilitate removal of deposited dirt. The dirt clean-out tube has a clear sight glass that when full allows the user to uncap and expel the separated dirt.

The term “cyclonic dirt separation tube” means the assembly that is comprised of “cyclonic outer tube” and the “cyclonic inner tube” that intakes dirty air through six intake ports, spins the mixture at high speeds to separate the dirt then expels the dirt down into the dirt collection chamber while sending clean air out the top to the clean air plenum and into the engine.

The term “cyclonic outer tube” means that portion of the “cyclonic dirt separation tube” that resides on the outermost part of the assembly.

The term “cyclonic inner tube” means that portion of the “cyclonic dirt separation tube” that resides on the inside of the assembly.

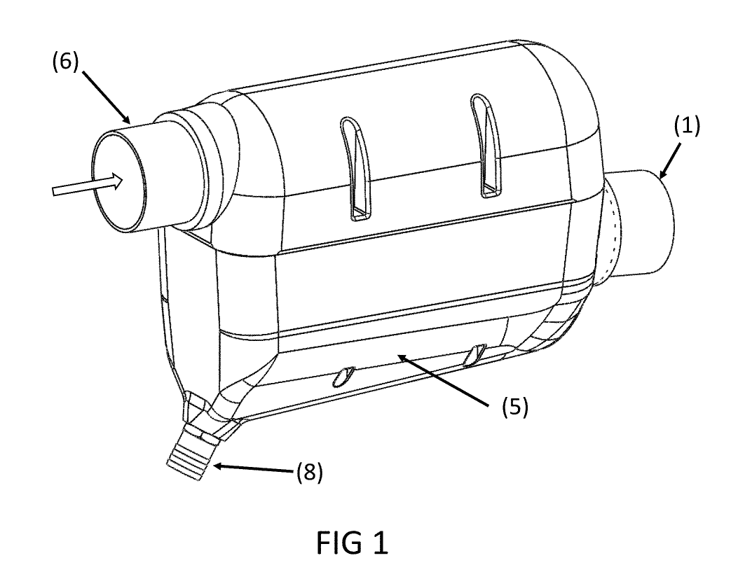

In one preferred embodiment of this invention, the structure of FIG. 1 takes in outside air through port (1) and that outside air passes through several cyclonic dirt separation tubes (2), each containing a cyclonic outer tube (3) with a cyclonic inner tube (4) nested inside of the cyclonic outer tube. The number of cyclonic dirt separation tubes in the device is preferably a number sufficient to maintain proper engine backpressure. As one example, it is preferred that an air filtration device of this invention that is attached to a 1000 cc engine would contain at least eight of the cyclonic dirt separation tubes. A larger-displacement engine would preferably contain a larger number of the cyclonic dirt separation tubes, in order to maintain proper engine intake backpressure.

Each cyclonic dirt separation tube separates out dirt particles and other foreign particles by spinning the intake air at high speed. These dirt separation tubes are specifically designed to allow proper engine intake flow and remove the specific sizes of dirt particles and other foreign particles ingested by vehicles operating off-road or on highways. This is accomplished by six intake ports on each cyclonic tube versus a single intake port seen in most cyclonic tube applications. In addition to the cyclonic tube an inner tube exists that deflects dirt to the cylindrical wall of the six-port cyclonic tube. The inner tube also creates a venture effect in the six-port cyclonic tube by reducing flow area and increasing particle speed as the dirt progresses down the length of the tube to the dirt collection chamber of the device. A cyclonic tube with a singular intake port can create upwards of 5 times the backpressure as a six-port intake used on these cyclonic tubes. The six port cyclonic tubes reduce the number of tubes required to maintain normal engine intake backpressure. This reduces the overall size of the device to a reasonable size similar to existing automotive filtration systems that utilize screens or porous media.

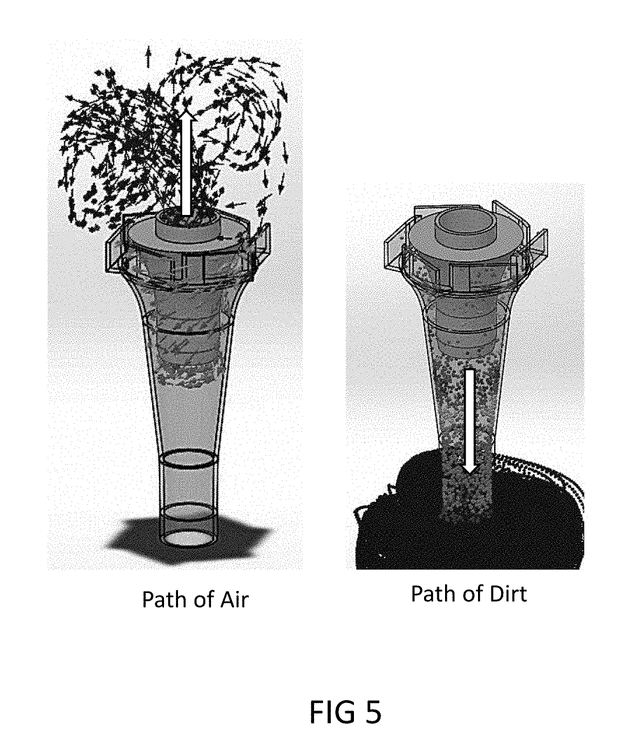

These particles fall to the bottom of each dirt separation tube, and then into the dirt collection chamber (5) while clean air exits out the top of the tube, as illustrated in FIG. 5, with said clean air then going to the engine via the engine intake (6) that is shown in FIG. 1.

The dirt collection chamber (5) shown in FIG. 1 not only collects the filtered-out particles but allows the user to see the amount of particles collected and to remove those particles by opening the sight glass plug on the dirt clean out tube (8).

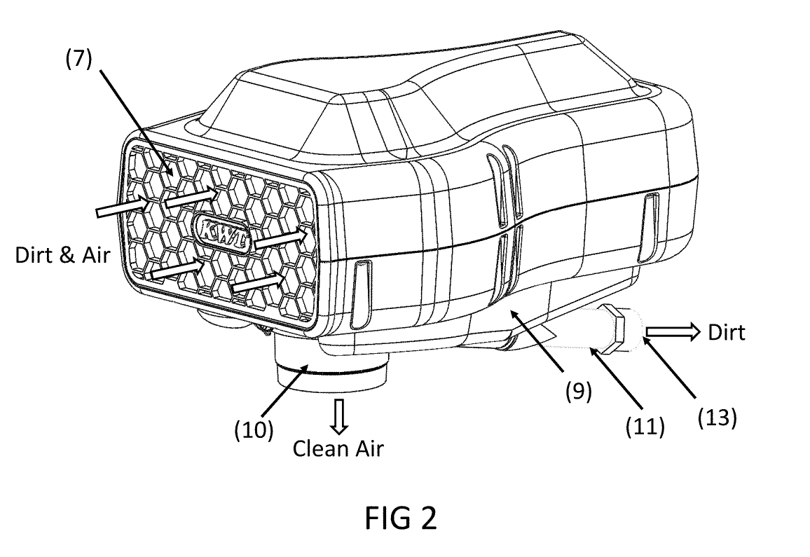

In another preferred embodiment, the air filtration device of this invention can take the form of FIG. 2 and be employed as a pre-filter between the intake of outside air and a vehicle's existing filtration system. Intake air flows in through the entry point (7) in FIG. 2 and into the cyclonic dirt separation tubes (2). As with the other preferred embodiment, it is preferred that the device contain several cyclonic dirt separation tubes as described herein, in a number sufficient to maintain proper engine backpressure. Again, each cyclonic dirt separation tube separates out dirt particles and other foreign particles by spinning the intake air at high speed. The particles fall to the bottom of the tube, and then into the dirt collection chamber (9) while clean air exits out the top of the tube, as illustrated in FIG. 5, with said clean air then going to the vehicle's filtration system, and ultimately into the engine, via the engine intake (10). As with the first-mentioned preferred embodiment, the dirt collection chamber (11) not only collects the filtered-out particles but allows the user to see the amount of particles collected and to remove those particles by opening the sight glass plug on the dirt clean out tube (13).

It is important to maintain the integrity of the air filtration device while in operation, including prevention of cracks or leaks, because the proper operation of the device of this invention relies upon keeping the clean air plenum sealed from outside dirty air and relies on keeping the dirt collection chamber sealed from atmospheric pressure.

In the first-mentioned preferred embodiment, the device may be used as a OEM filter replacement and connected directly to the existing engine air intake, and the use of flexible ducting may be required. In the second-mentioned preferred embodiment, the device may be used as a pre-filter and could be connected to the vehicle's air cleaner intake box; again, the use of flexible ducting may be required.

In either preferred embodiment, during rainy conditions the device is designed to shed water through weep holes located at the bottom of the intake plenum. The cyclone tube's six port inlet is located atop the intake plenum to reduce ingestion of water. In rainy conditions, dust and sand are not present, so separation of dirt from air is typically not a concern. If the device is used in a downpour, the dirt collection chamber should be opened to allow water and dirt to drain. This operation should also be followed when the dirt collection chamber becomes full and indicated by the sight glass located at the bottom of the dirt collection chamber. The size of the device fits in usable space behind the cab above the mid-engine on most off-road high-performance vehicles. For automotive vehicles normally licensed for DOT on-road use or military off-road vehicles, the device may be sized to fit where the OEM air filter box is normally located in the engine bay as a replacement; or when used as a pre-filter, the device may be mounted outside the engine bay and routed to the filter box via flexible ducting. In either preferred embodiment described herein, the device may be made from high temperature plastic and service temperatures up to 180 degrees Fahrenheit.

The air filtration device of this invention may be utilized on, and sized for, many different types of motorized vehicles, including but not limited to: Off-road vehicles such as all-terrain vehicles (including quads, quad bikes, three-wheeler ATVs, and four-wheeler ATVs); off-road motorcycles including dirt bikes; vehicles that can be driven both on- and off-road such as pickup trucks, modified trucks, recreational vehicles, passenger cars, delivery trucks, and delivery vans; military motor vehicles used in off-road and/or all-terrain applications; and construction motor vehicles such as bulldozers, tractors, cranes, forklifts, and backhoes. Those skilled in the art will readily understand that for larger-displacement engines, it will be desirable to size the device appropriately to accommodate the particular engine and to include, within the device, a larger number of cyclonic dirt separation tubes than would be utilized in instances when the device is employed with smaller-displacement engines.

It will be apparent to those skilled in the art that various other modifications and changes to the structures, dimensions, and features described herein may be made without departing from the spirit of the invention and the scope of the appended claims.

What is claimed is:

1. An air filtration device for use as the primary filter of intake air to a motor vehicle's engine, comprising:
a. External housing that has one or more air intake ports and one or more exit ports through which cleaned air exits into the engine;
b. Several cyclonic dirt separation tubes, in a number sufficient to maintain engine backpressure that is appropriate for the size of said engine, each of said dirt separation tubes comprising an outer tube and an inner tube;
c. A clean air chamber within said external housing, into which clean filtered air flows from said dirt separation tubes prior to being delivered to the engine;
d. A dirt collection chamber within said external housing, into which dirt particles and other foreign particles drop and are collected;
e. A dirt clean out tube attached to said dirt collection chamber, with an attached plug/sight glass, to enable removal of the collected dirt particles and other foreign particles and to be utilized as an indication that the dirt collection chamber is full.

2. The air filtration device of claim 1, wherein the dirt clean out tube is detachable.

3. An air filtration device for use as a pre-filter of intake air prior to air flow into a motor vehicle's engine-air filtration system, comprising:
a. External housing that has one or more air intake ports and one or more exit ports through which cleaned air exits into the vehicle's engine-air filtration system;
b. Several cyclonic dirt separation tubes, in a number sufficient to maintain engine backpressure that is appropriate for the size of said engine, each of said dirt separation tubes comprising an outer tube and an inner tube;
c. A clean air chamber within said external housing, into which clean filtered air flows from said dirt separation tubes prior to being delivered to the engine;
d. A dirt collection chamber within said external housing, into which dirt particles and other foreign particles drop and are collected;
e. A dirt clean out tube attached to said dirt collection chamber, with an attached plug, to enable removal of the collected dirt particles and other foreign particles.

4. The air filtration device of claim 3, wherein the dirt clean out tube is detachable.
